(19) United States
(12) Patent Application Publication
(10) Pub. No.: US 2022/0061355 A1
(43) Pub. Date: Mar. 3, 2022

(54) PROCESS OF OBTAINING CHEWABLE SNACK-TYPE ARTICLE FOR DOGS AND CHEWABLE SNACK-TYPE ARTICLE FOR DOGS

(71) Applicant: Nilson Riga Vitale, Sao Paulo (BR)

(72) Inventor: Nilson Riga Vitale, Sao Paulo (BR)

(21) Appl. No.: 17/301,262

(22) Filed: Mar. 30, 2021

(30) Foreign Application Priority Data
Aug. 27, 2020 (BR) BR102020017506-8

(51) Int. Cl. A23K 10/26; A23K 40/00; A23K 50/42; B65B 5/04; A01K 15/02

(52) U.S. Cl. CPC A23K 10/26; A23K 40/00; C14B 1/02; B65B 5/045; A01K 15/026; A23K 50/42

(57) ABSTRACT

The present invention refers to the process of obtaining ‘leather bone’ type snacks, commonly used by dog tutors as snacks and as a treat for the animal in dressage processes, comprised of simple stages of execution, one of the stages being chemical and other ones being mechanical, and free of components potentially harmful to the animal's health, such as flavorings, dyes, glue and resins, thus solving a technical problem related to the need to minimize risks to animal health, due to the use of harmful components in the manufacturing process of the product.

### BRIEF DESCRIPTION

The present application for patent of invention refers of a “PROCESS OF OBTAINING CHEWABLE SNACK-TYPE ARTICLE FOR DOGS AND CHEWABLE ARTICLE OF THE SNACK TYPE FOR DOGS”, which refers to the process of obtaining ‘leather bone’ type snacks, commonly used by dog tutors as snacks and as a treat to the animal in training processes, free of toxic components for the animal, such as dyes, flavorings, resins and glues.

### FIELD OF APPLICATION

The present invention pertains to the section of human need, to the field of veterinary science, more specifically, to the field of food products specially adapted to animals and method of production thereof, because it is a product for dogs produced from residual material, more specifically, from leather or skin; since it refers to the process of obtaining a snack-type chewable article for dogs, popularly known as ‘leather bone’.

### CONVINCING

The popular ‘bones’ offered to dogs as a snack and as a treat in dressage processes promote animal welfare, recreation, cleaning of teeth and help strengthen the muscles of the mouth, neck and forepaws of the animal. It is a widely used food item, but it does not replace meals, because it does not offer the nutrients necessary for the proper maintenance of the animal's health.

Snacks of this type, also known as ‘leather bones’, although widely used, are considered controversial, precisely due to their production process. The raw material used in production is considered a by-product of the tannery industry, and some veterinarians and tutors do not recommend the use of these products, because the production process thereof involves several chemical components that are harmful to the animal's health, such as hydrogen peroxide, dyes, artificial flavorings, among others.

Despite the well-being provided to the animal, the biggest problem associated with this type of product lies in the long list of chemical components used in its obtainment process, which can be harmful to the animal, such as: hydrogen peroxide; lead, mercury and arsenic-based preservatives; artificial dyes, such as titanium dioxide; and, in some cases, glues, so that the bones do not come apart. Some research conducted with snack samples revealed residues of various toxic substances, many of which are considered carcinogenic.

In general, the production processes of these products comprise: an initial stage of chemical bath of the raw material; treatment with chemical components to facilitate the removal of hair from the leather; chemical treatment to inflate the leather and separate its layers; washing and bleaching of the layer of interest; painting; application of preservative to ensure the durability of the product; and formatting the product by gluing.

In view of the technical problem related to the process of obtaining the ‘leather bones’, the present invention provides a production process with simple stages of execution, free of the chemical components usually employed and considered harmful, and which, therefore, minimizes the adverse effects arising from the consumption of this type of snack and maximizes the benefits provided, such as strengthening the muscles of the mouth, neck and forelimbs; cleaning of teeth and removal of tartar; in addition to promoting recreation for the animal.

### BACKGROUND OF THE INVENTION

The current state of the art has some prior arts that describe processes of obtaining chewable snacks for dogs. However, the process described in the present invention differs from them by not employing chemical components considered harmful to the animal's health or edible resins, so the product obtained is therefore more natural, being produced from a process with simple execution steps that minimizes the adverse effects arising from the consumption of this type of snack and maximizes the benefits provided to the animal.

The prior art P10712869-0, entitled “Method for forming a chewable for animal possessing an exterior”, describes how to obtain chewable toys consisting of raw hide and edible resin, which is characterized by being a starch or gluten-based resin, and may cover all or a portion of the leather or be retained within it. The described obtainment process comprises the extrusion and compression molding of the leather, in the form of particulate, and the composition of the resin. The prior art differs from the present invention by describing the use of a resin composition and by comprising extrusion steps of the material, in addition to employing a leather particulate.

The prior art PT1404173, entitled “Dog bone with pieces of dried meat and manufacturing process thereof”, describes a gnawing element for an animal that comprises a composite of pieces of animal skin, adherent and discrete pieces of flavoring product interspersed in the composite. The product has two sides and comprises a flavoring element, partially housed in the composite, which extends from the first side to the second side of the proposed bone. Unlike this proposal, the prior art comprises a composite that presents pieces of meat and animal skin, in addition to gelatin, in addition, the product is extruded for formatting, while the present invention is characterized by comprising only processed animal leather and free of flavorings.

The prior art PT1006789E, entitled “Biting toys for domestic carnivorous animals and method for manufacturing them”, refers to a toy consisting of an outer layer comprised of raw hide, including said outer layer a longitudinal seam in it; an inner element comprised of smoked dried meat, and this element is wrapped by the outer layer, which extends for a part of the inner element through the seam present in the outer layer and exposed. The product described is obtained from two phases, in the first there is provided a raw hide sheet element and the dry meat element; then the sheets of raw hide and dried meat are overlapped, and then the two elements moved together so that the raw hide sheet wraps around that of dried meat. Unlike the present invention, the prior art describes a product that comprises a filling of dried meat. It is important to highlight that the process of obtaining the two products consists of different steps. In addition, the prior art mentions the treatment of leather using lime water, hydrogen peroxide and chlorine, and uses sodium sorbate as a preservative, so a much larger amount of chemical agents compared to the present invention which uses only sodium metabisulfite as a preservative, early in processing.

The prior art BR0317621B1, entitled “Chew toy and chew-resistant article for carnivorous domestic animals”, describes a chew toy that comprises a combination of raw hide and pork skin suitably shaped like a bone, roll, donut or sundry other shapes. The raw hide and pigskin are supplied as sheets that are rolled, sandwiched together or otherwise interspersed to form a chew toy that has enhanced taste and smell, thereby encouraging the animal to chew the toy. Unlike the present invention, the prior art employs dyes and flavorings in its process, in order to make the toy more attractive to the animal. In addition, the toy combines raw hide and pigskin, while the present invention employs only the scraping, coming from the leather, as raw material.

From the analysis of the current state of the art, it is noted that none of the recovered prior arts describes a process of obtaining with simple stages of execution of snack-type chewable article for dogs, known as ‘leather bones’, free of chemical components such as flavorings, dyes, glues and resins that can be harmful to the animal, and that uses as raw material only the scraping, coming from the leather. Therefore, the present invention solves the technical problem related to the need to minimize risks to animal health, due to the use of harmful components in the manufacturing process of the product.

### Objective of the Invention

The objective of the present invention is to provide a process of obtaining with simple stages of execution and that use only leather scrapings as raw material, being free of chemical components harmful to health, such as flavorings, dyes, resins and glues.

### The Invention

The present invention describes obtaining a chewable article for dogs through a process that employs leather scraping as raw material, only one chemical component, sodium metabisulfite, as a preservative agent, and mechanical steps of rinsing, cutting, storage, assembly and drying of the product. It is therefore free of chemical components potentially harmful to the animal's health, such as flavorings, dyes, resins and glues.

### Advantages of the Invention

The main advantages of the present invention are:
Provision of a process of obtaining a chewable article for dogs with simple stages of execution, characterized by presenting only one chemical stage, the others being mechanical;
Provision of a process of obtaining chewable article for dogs that dispenses with the use of flavorings, dyes, glue snags and resins, and therefore provides a product free of chemical components potentially harmful to animal health.

### DESCRIPTION OF THE DRAWINGS

The invention will be described in a preferred embodiment, so for improved understanding, references will be made to the related figures:

FIG. 1: Flowchart of the process of obtaining the chewable article for dogs;

FIG. 2: Images of the chewable article in its variations of shape, roll or donut.

### DETAILED DESCRIPTION OF THE INVENTION

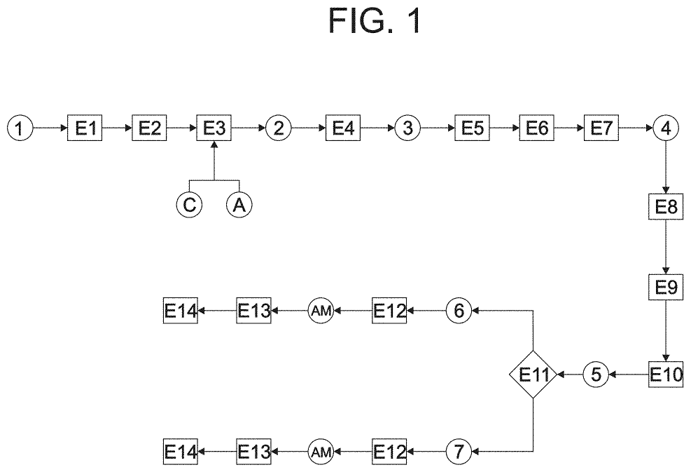

The process of obtaining the chewable article for dogs (FIG. 1) begins with the receipt (E1), weighing (E2) and packaging (E3) of raw hide (1), from approved and approved suppliers, in a tank containing 90% sodium metasulfite solution (C) and drinking water (A), with concentration of 5% of the weight of raw hide (1) of sodium metabisulfite (C), for 1 hour. After this period, the green leather (2) is fleshed (E4), in a fleshing machine, so that there is separation of residual meats by pressure, the step takes place in 10 seconds. After fleshing (E4), the fleshed leather (3) is arranged on an easel for separation (E5) of head and grupon, in the presence of fat shavings from the fleshing, the grupon is retapered, then the division (E6) is made and the hair is withdrawn (E7) in a dividing machine, with a rotation speed of 35 rpm, the scraping (4) being obtained with thickness between 22 and 27 lines, the raw material processed. Then, the scraper (4) is dried (E8), in a dryer, with 40 kg of pressure, and then stretched (E9) on cutting tables, equipped with jigs, where it is cut (E10) into strips (5), which will be mounted (E11) in roll (6) or donut (7) shape. For roll mounting (6), the strips (5) are arranged with the roughest surface up, are rolled and have their sides cut with the knife when necessary. For the assembly of the donut (7), a roll (6) is prepared that is finished with another strip (5) that is wrapped over it, joining its two ends. After assembly (E11), the rolls (6) and the donuts (7) are packed on conveyor belts and taken to the greenhouse at 90° C. for 120 minutes for drying (E12), until they reach 10% of moisture. If it is verified that moisture has not been reached, the product returns to the greenhouse, where it is kept at 75° C., until moisture of 10% is reached. After drying (E12), the chewable article for dogs (CA) is packed (E13) in raffia bags and subsequently wrapped (E14).

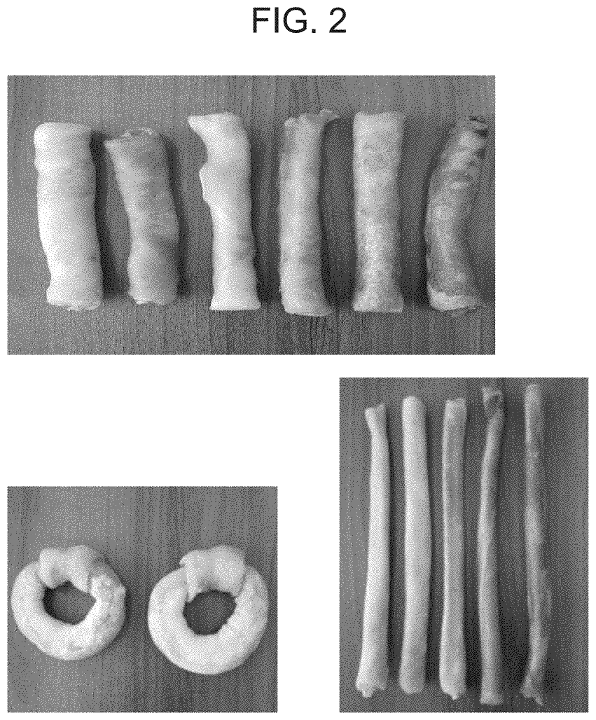

The two models of the chewable article (CA), roll and donut ready for consumption are seen in FIG. 2.

1) A PROCESS OF OBTAINING SNACK-TYPE CHEWABLE ARTICLE FOR DOGS wherein said process starts with the receipt (E1), weighing (E2) and packaging (E3) of raw hide (1) in a tank containing a solution of 90% sodium metabisulfite (C) and drinking water (A), with concentration of 5% of the weight of the raw hide (1) of sodium metabisulfite (C), for 1 hour; after this period, the green leather (2) is fleshed (E4), in a pressure fleshing machine, for 10 seconds; after the fleshing (E4), the fleshed leather (3) is arranged on an easel for separation (E5) of head and grupon, then the division (E6) and the removal of the hairs (E7) is carried out in a dividing machine, with a rotation speed of 35 rpm, and the scrapes (4) with thickness between 22 and 27 lines are obtained; then the scraping (4) is dried (E8), in a dryer with 40 kg of pressure, and stretched (E9) on cutting tables, equipped with jigs, where it is cut (E10) into strips (5), which will be mounted (E11) in roll (6) or donut shape (7); for mounting the rolls (6), the strips (5) are arranged with the roughest surface upwards, rolled and have their sides cut with the knife, when necessary; for the assembly of the donut (7), a roll (6) is prepared that is finished with another strip (5) that is wrapped over it, joining its two ends; after assembly (E11), the rolls (6) and the donuts (7) are packed on conveyors and taken to the greenhouse at 90° C. for 120 minutes for drying (E12), until they reach 10% of moisture, if it is verified that moisture has not been reached, the product returns to the greenhouse, where it is kept at 75° C., until moisture of 10% is reached; after drying (E12), the chewable article for dogs (CA) is packed (E13) in raffia bags and subsequently wrapped (E14).

2) THE SNACK-TYPE CHEWABLE ARTICLE FOR DOGS, obtained according to claim 1, wherein said article is leather scrapings formatted in a roll (6) or donut (7).
